(19) United States
(12) Patent Application Publication
(10) Pub. No.: US 2010/0023730 A1
(43) Pub. Date: Jan. 28, 2010

(54) Circular Register Arrays of a Computer

(75) Inventor: Steven Leeland, Scottsdale, AZ (US)

Correspondence Address: HENNEMAN & ASSOCIATES, PLC, 70 N. MAIN ST., THREE RIVERS, MI, 49093, US

(73) Assignee: VNS PORTFOLIO LLC, Cupertino, CA (US)

(21) Appl. No.: 12/179,494

(22) Filed: Jul. 24, 2008

(51) Int. Cl. G06F 15/76; G06F 9/06

(52) U.S. Cl. 712/202; 712/E09.003

(57) ABSTRACT

The invention provides a method and apparatus for eliminating the stack overflow and underflow in a dual stack computer 100 while remaining fully operational in case of single event upset caused by radiation and a method and apparatus for eliminating stack overflow and underflow by replacing a conventional stack with a circular stack array 125B coupled to a plurality of multiplexers 205a-h to function in a circular repeating pattern. The method of the invention provides for the stack to remain operational in the event of single event upset by using one hot logic multiplexers 205a-h. Thus in case of single event upset, where the logic state of the control signals can be corrupted such that at a given time both the push or pop control signals are active, the multiplexers will not shift the data either upward or downward in the data stack 145 and the return stack 120 and prevents the processor system 100 from entering into an unknown state.

### BACKGROUND OF THE INVENTION

1. Field of the Invention

The present invention relates to the field of computers and computer processors, and more particularly to a method and means for a more efficient use of a stack within a stack computer processor.

2. Description of the Background Art

Stack machines offer processor complexity that is much lower than that of Complex Instruction Set Computers CISCs, and overall system complexity that is lower than that of either Reduced Instruction Set Computers RISCs or CISC machines. They do this without requiring complicated compilers or cache control hardware for good performance. They also attain competitive raw performance, and superior performance for a given price in most programming environments. Previously, the stacks were kept mostly in program memory; newer stack machines maintain separate memory chips or even an area of on-chip memory for the stacks. These stack machines provide extremely fast subroutine calling capability and superior performance for interrupt handling and task switching.

However, there is no hardware detection of stack overflow or underflow conditions. Stack overflow occurs when there are not a sufficient number of registers available and results continue to be pushed onto the stack, causing the bottom registers to be overwritten. Stack underflow occurs when all registers have been emptied, and continued popping of a stack produces unintentional or incorrect results. Some other stack processors use stack pointers and memory management such that an error condition is flagged when a stack pointer goes out of range of memory allocated for the stack. U.S. Pat. No. 6,367,005, issued to Zahir, et al., discloses a register stack engine, which saves to memory sufficient registers of a register stack to provide more available registers in the event of stack overflow. The register stack engine also delays the microprocessor until the engine can restore an appropriate number of registers in the event of stack underflow.

U.S. patent application Ser. No. 11/503,372 addresses the problem of stack overflow and underflow by replacing a conventional stack by an array of registers which function in a circular, repeating pattern. This circular, repeating pattern is accomplished through utilization of an associated bi-directional shift register which contains a plurality of one bit shift registers electrically interconnected in an alternating pattern. This configuration prevents reading from outside of the stack, and prevents reading an unintended empty register value. While the above-described method did effect the improvement of enabling a circular stack to prevent the overflow and underflow, that method was less than ideal if more than one bit is set to a ‘1’ because of single event upset, where the bits of the shift registers are corrupted by the radiation. If more than one of the bits of the shift registers is set to ‘1’, the successive operations will receive corrupted data or may not able to perform the required operations and can enter an unknown state. The above method also fails to operate if all the bits of the bidirectional shift register is set to ‘0’ and enters an unknown state. Thus, there is a need for a robust system that is operational in case of single event upset and yet able to eliminate overflow and underflow within a stack.

### SUMMARY OF THE INVENTION

The present invention provides a method and apparatus for eliminating the stack overflow and underflow in a dual stack computer while remaining fully operational in case of single event upset caused by radiation. More importantly, the present invention provides a method and apparatus for eliminating stack overflow and underflow by replacing a conventional stack with a circular stack array which is coupled to a plurality of multiplexers to function in a circular repeating pattern. This circular repeating pattern is accomplished through utilization of a plurality of multiplexers which, on receiving control signals from the decode logic, shifts the data up or down in the data stack registers and return stack registers. This configuration prevents reading from outside of the stack, and prevents reading an unintended empty register value.

Each multiplexer in the data stack and return stack provides input to one stack register of the circular stack array, while accepting inputs from a proceeding and a succeeding stack register of the circular array. The multiplexer shifts the data by providing data of the preceding or succeeding stack register as the input to the stack register. On receiving the active pop signal, multiplexer provides input of the succeeding stack register as the input to the stack register thus shifting data up in the data stack and the data of the top stack register is written to the bottom stack register in the circular array to avoid underflow. On the other hand, if an active push signal is received, multiplexer provides input of the preceding stack register as the input to the stack register, thus shifting data down in the data stack and the return stack and the data of the bottom stack register is written over to avoid overflow.

The present invention also provides a method and apparatus for the stack to remain operational in the event of single event upset by using one hot logic multiplexers. The one hot logic multiplexer only performs an operation if only one of the push or pop control signals is active. Thus, in case of single event upset, where the logic state of the control signals can be corrupted such that at a given time both the push or pop control signals are active, the multiplexers will not shift the data either upward or downward in the data stack and the return stack and prevents the processor system from entering into an unknown state.

### BRIEF DESCRIPTION OF THE FIGURES

FIG. 1 is a block diagram depicting a general layout of a stack computer;

FIG. 2 is a data stack according to the present invention;

FIG. 3 is a return stack according to the present invention;

FIG. 4 is a more detailed view of a single register of a stack and multiplexer;

FIG. 5 is a method of operation of a stack computer;

FIGS. 6a and 6b are a method of operation in a circular data stack registers on receiving push and pull control signals; and,

FIGS. 7a and 7b are a method of operation in a circular return stack registers on receiving push and pull control signals.

### DETAILED DESCRIPTION OF THE FIGURES

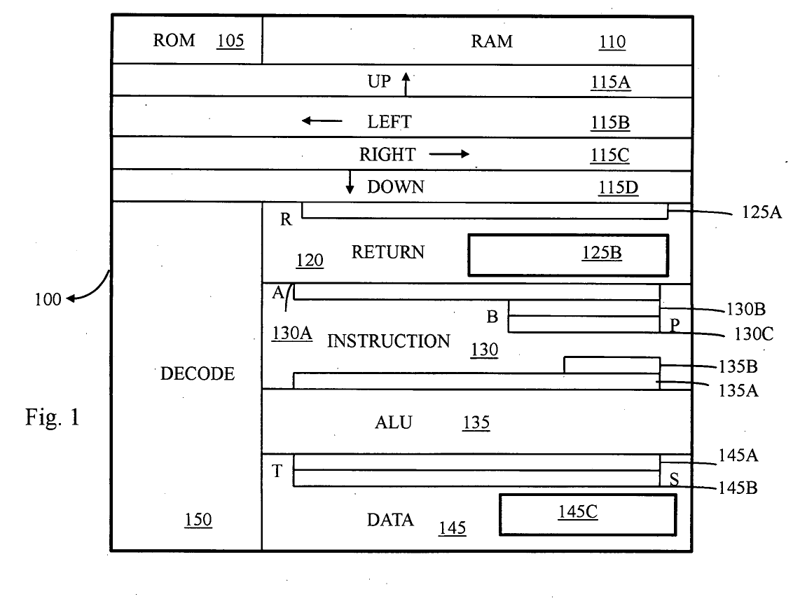

FIG. 1 is a block diagram depicting the general layout of a dual stack computer 100 as used in the present invention. The computer 100 is generally a self contained computer having its own ROM 105 and RAM 110. The computer consists of a return stack 120 for storing return addresses, consisting of 18-bit R register 125A and a circular array of stack registers 125B and a data stack 140 which is used for computation purposes, consisting of 18-bit T register 145A, 18-bit S register 145B and a circular array of data stack registers 145C. Other basic components of the computer 100 are the instruction area 130 includes an A register 130A, B register 130B and P register 130C. In this example, the A register 130A is a full eighteen-bit register, while the B register 130B and the P register 130C are nine-bit registers. Computer 100 also includes an arithmetic logic unit 135 to perform arithmetic operations and a decode logic section 150 for decoding instructions received by the computer 100. The computer 100 communicates with the processors that can be connected orthogonally using the communication ports UP 115A, LEFT 115B, RIGHT 115C and DOWN 115D.

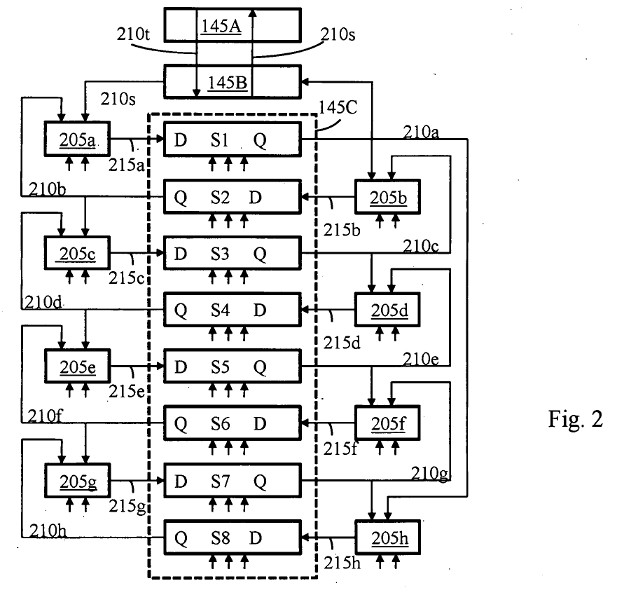

FIG. 2 discloses an embodiment of the data stack 140 according to the present invention. The top two registers in the data stack 140 are an 18-bit T register 145A and 18 bit S register 145B. The circular array of data stack registers 145C includes additional eight 18-bit data stack registers, S1 through S8 arranged in a circular array. The eight 18-bit data stack registers S1 through S8 can operate in the absence of the 18-bit T register 145A and 18-bit S register 145B. However, the presence of at least the 18-bit S register 145B in combination with the 18-bit data stack registers S1 through S8 provides faster access and optimum for timing, and therefore provides higher operating speed of the 18-bit data stack registers S1 through S8. In addition, the 18-bit S register 145B acts as a buffer between the 18-bit data stack registers S1 through S8 and the rest of the processor system. This provides independence of timing between the 18-bit data stack registers S1 through S8 and the rest of the processor system 100.

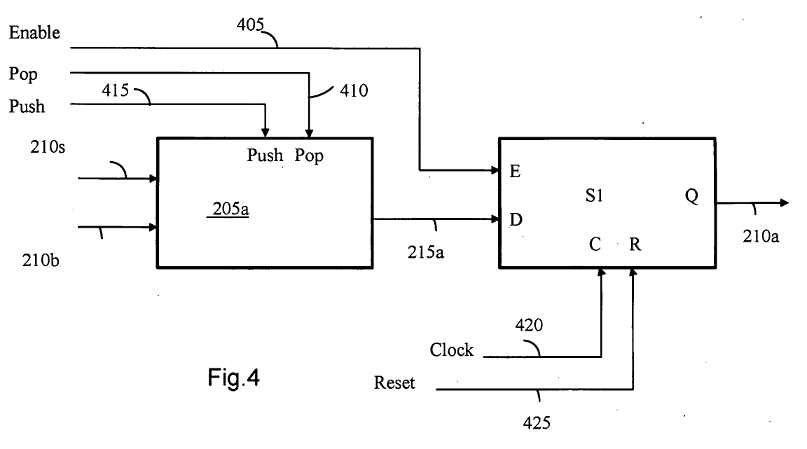

This embodiment also includes of logic circuitry which includes a plurality of multiplexers 205a through 205h that provide data to the 18-bit data stack registers S1 through S8 145C based on the control signals control signals to the multiplexers and stack registers will be explained in detail in FIG. 4. The number of multiplexers 205a through 205h is equal to the number of 18-bit data stack registers S1 through S8 located below the 18-bit S register 145B. Each multiplexer 205a through 205h provides input to one of the 18-bit data stack registers S1 through S8 as shown in FIG. 2. The multiplexers 205a through 205h are electrically connected with 18-bit data stack registers S1 through S8 such that the 18-bit data stack registers S1 through S8 operate in the sequential circular interconnect pattern. Each multiplexer 205a through 205h receives input from stack register immediately preceding and the stack register succeeding the stack register connected to the multiplexer. For example, the multiplexer 205c providing input to the stack register S3 receives data 210b and data 210d from the preceding 18-bit stack registers S2 and successive 18-bit stack register S4 respectively. Multiplexer 205c provides either the data received from the preceding 18-bit stack register S2 or the 18-bit successive register S4 based on the control signal input received which is shown in detail in FIG. 4.

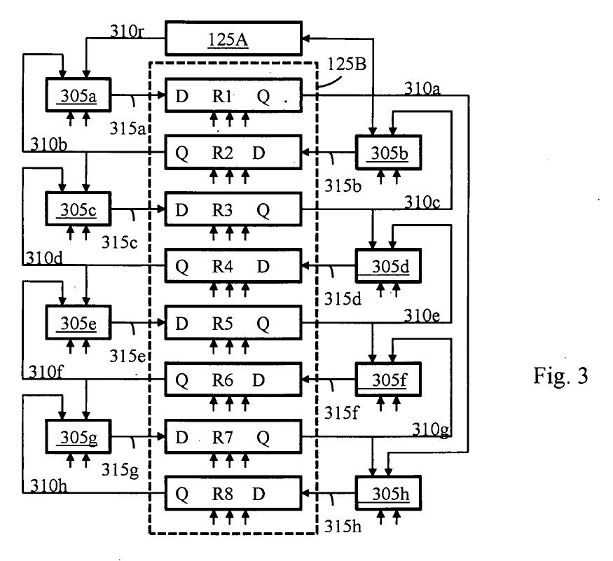

FIG. 3 discloses the return stack 120 according to the present invention. The return stack 120 includes the 18-bit R register 125A, and circular array of stack registers 125B. The circular array of stack registers 125B includes eight additional 18-bit return stack registers R1 through R8 located below the 18-bit R register 125A. The 18-bit return stack registers R1 through R8 are arranged in a circular array and can operate in the absence of the 18-bit R register 125A. However, the presence of at least the 18-bit R register 125A in combination with 18-bit return stack registers R1 through R8 provides faster access circuitry and an optimum for timing, and therefore provides higher operating speed. In addition, the 18-bit R register 125A acts as a buffer between the 18-bit return stack registers R1 through R8 and the rest of the processor system 100.

This embodiment also includes logic circuitry, which includes a plurality of multiplexers 305a through 305h that provide data to the 18-bit return stack registers R1 through R8 based on the control signals control signals to the multiplexers and stack registers are explained in detail in FIG. 4. The number of multiplexers 305a through 305h is equal to the number of bottom 18-bit return stack registers R1 through R8 located below the 18-bit R register 125A. Each multiplexer 305a through 305h provide input to the one of the 18-bit return stack registers R1 through R8 as shown in FIG. 3. The multiplexers 305a through 305h are electrically connected with 18-bit return stack registers R1 through R8 such that the 18-bit return stack registers R1 through R8 operate in the sequential circular interconnect pattern. Each multiplexer 305a through 305h receives input from stack register immediately preceding and the stack register succeeding the stack register connected to the multiplexer. For example, the multiplexer 305c providing input to the stack register R3 receives data 310b and data 310d from the preceding 18-bit stack registers R2 and successive 18-bit stack register R4 respectively. Multiplexer 305c provides either the data received from the preceding 18-bit stack register R2 or the 18-bit successive register R4, based on the control signal input received which is shown in detail in FIG. 4.

FIG. 4 is an expanded view of the interface between one of the 18-bit data stack register S1 with one of the multiplexers 205a which provides the data 215a to the 18-bit data stack register S1. Each 18-bit data stack register S1 through S8 and 18-bit return stack registers R1 through R8 receives the enable signal 405 from the decode logic section 150 and clock signal 420 and reset signal 425. Even though FIG. 4 shows only the interface between one of the 18-bit data stack registers S1 with one of the multiplexers 205a which provides the data 215a, it would be obvious to one skilled in the art that the interface between the rest of the 18-bit data stack registers S1 through S8 and the multiplexers 205b through 205h and the interface between 18-bit return stack registers R1 through R8 and the multiplexers 305a through 305h is same as depicted in FIG. 4. Multiplexers 205a through 205h and multiplexers 305a through 305h receive the pop 410 and push 415 control signals from decode logic section 150 to pop and push data from and to the 18-bit data stack registers S1 through S8 and 18-bit return stack registers R1 through R8 respectively. Multiplexers 205a through 205h and multiplexers 305a through 305h are implemented using one hot logic circuitry, wherein the multiplexers 205a through 205h and multiplexers 305a through 305h perform operations only if one of the pop 410 and push 415 control signals from decode logic section is active. If one or more of the pop 410 and push 415 control signals logic state are flipped due to single event upset, such that both the pop 410 and push 415 control signals are at a logic state of ‘1’ or ‘0’, the multiplexers 205a through 205h and multiplexers 305a through 305h will not perform any operation other than entering into an unknown state.

The multiplexer 205a providing data 215a to the 18-bit data stack registers S1 is coupled with the output 210s of the 18-bit S register 145B and output 210b of the successive-bit data stack registers S2. Multiplexer 205a provides the 18-bit data stack registers S1 either data output 210s of the 18-bit S register or output 210b of the successive 18-bit data stack registers S2 as input 215a depending on if the push control signal 415 or the pop control signal 410 is active. If an active push control signal 415 is received, the multiplexer 205a provides data 210s from the 18-bit S register 145B as the input 215a to the 18-bit data stack register S1. If an active pop control signal 410 is received, the multiplexer 205a provides data 210b from the successive 18-bit stack register S2 as the input 215a to the 18-bit data stack registers S1. In one embodiment, multiplexers 205a through 205h and multiplexers 305a through 305h are all implemented using one hot logic methodology, wherein only one of the control inputs can be active at any given point. No data operations are performed if both push 415 and pop 410 control signals are active or inactive at the same time.

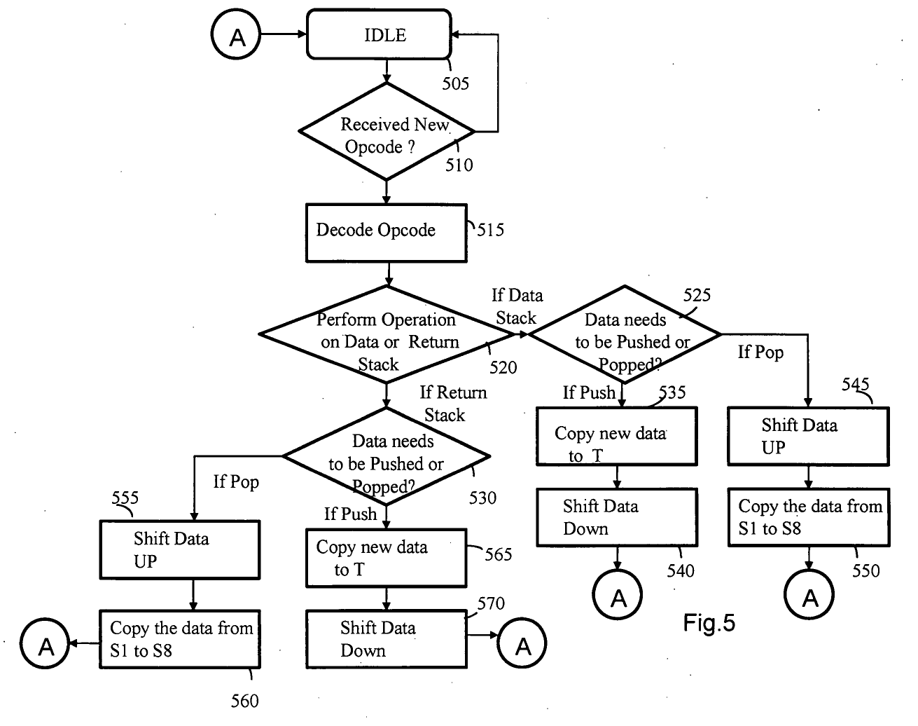

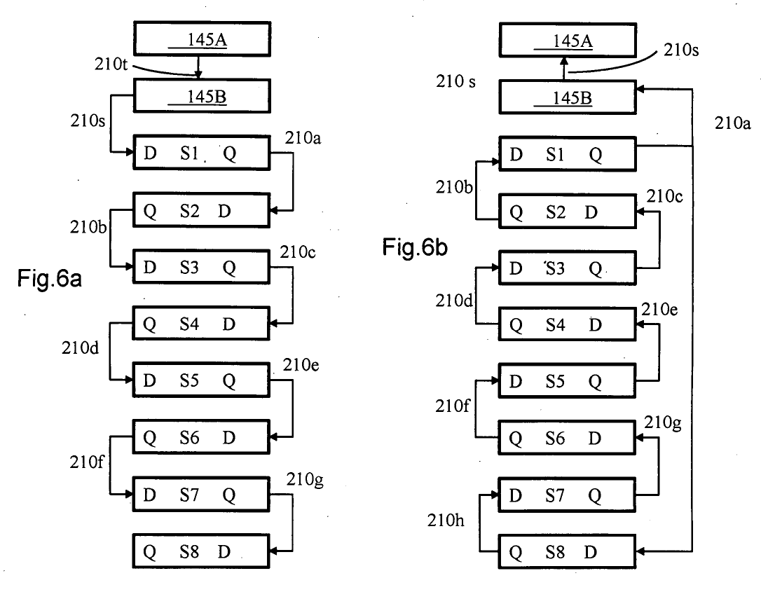

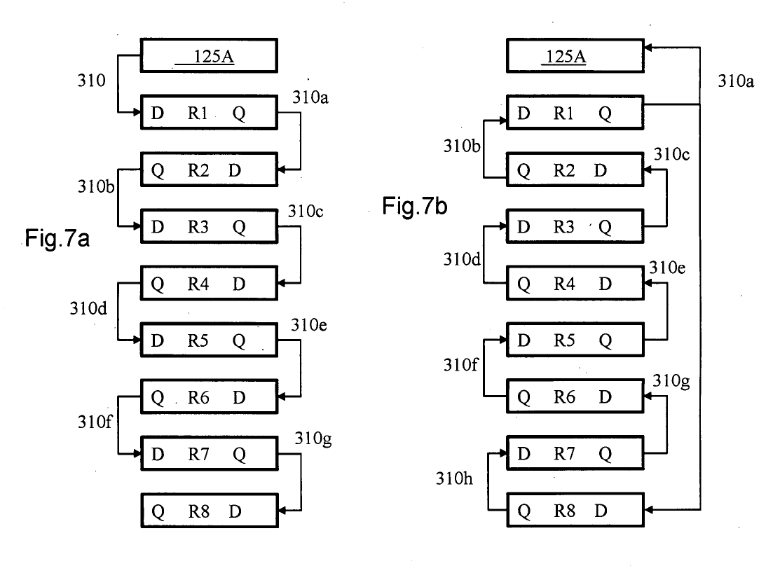

FIG. 5 illustrates one embodiment of method for circular stack operation of the stack computer 100 on receiving the instruction opcode. The stack computer 100 remains in the idle state on receiving the power up condition step 505. The stack computer 100 verifies to determine if a new opcode is received and if opcode is not received, then it returns to the idle state step 510. If a new opcode is received, then decode logic section 150 decodes the opcode and verifies if the data operation needs to be performed on the return stack 120 or data stack 140 step 515 and step 520. If the data operation needs to be performed in the data stack 140, the decode logic section 150 determines if data needs to be pushed into or popped out of the data stack step 525. If the data needs to be pushed into the data stack 140, the new data is moved into the 18-bit T register 145A and the data in 18-bit S register 145B and 18-bit data stack registers S1 through S8 is shifted down, which will be explained in FIG. 6a steps 535 and 540. If the data needs to be popped out of the data stack 140, the data in the 18-bit data stack registers S8 through S2 is shifted up and data from the 18-bit stack register S1 is copied to 18-bit stack register S8, which will be explained in FIG. 6b steps 545 and 550. If the data operation needs to be performed in the return stack 120, the decode logic section 150 determines if data needs to be pushed into or popped out of the return stack 120 step 530. If the data needs to be popped out of the return stack 120, the data in the 18-bit return stack registers R8 through R1 is shifted up and data from the 18-bit return stack register R1 is copied to 18-bit return stack register R8, which will be explained in FIG. 6b steps 555 and 560. If the data needs to be pushed into the return stack 120, the new data is moved into the 18-bit R register 125A and the data from the 18-bit return stack registers R1 through R8 is shifted down, which will be explained in FIG. 7a steps 565 and 570.

FIG. 6a illustrates one embodiment of a method of shifting data to avoid overflow when decode logic section 150 detects a push instruction to be performed on the data stack 140. The decode logic section 150 sends an active push control signal 415 to the multiplexers 205a through 205h. A ten cell deep push down stack is formed by the 18-bit T register 145A, 18-bit S register 145B and 18-bit data stack registers S1 through S8. The new data to be pushed is written to the 18-bit T register 145A, the data from the 18-bit T register 145A is written to 18-bit S register 145B and the data of the 18-bit S register 145B is shifted down to the 18-bit data stack register S1 and the data from the 18-bit data stack registers S2 through S8 145C is shifted down to the 18-bit data stack registers S2 through S8 145C on receiving the active push control signal 415. The data that was previously present in the data stack registers will be shifted down in the following fashion T→S→S1→S2→S3→S4→S5→S6→S7→S8 and the data in the S8 register are lost as shown in FIG. 6a. There is no stack overflow and if more than ten items are written, only the last ten will remain; each store after the first ten will overwrite one of the S1 through S8 registers.

FIG. 6b illustrates one embodiment of a method of shifting data to avoid underflow when decode logic section 150 detects a pop instruction to be performed on the data stack 140. The decode logic section 150 provides an active pop signal 410 to the multiplexers 205a through 205h. A ten cell deep pop up stack is formed by the registers T 145A, S 145B, and S1 through S8, and on receiving an active pop signal 140, the data from the 18-bit data stack registers S1 through S8 will be shifted up and the data from S1 register will be copied to the S8 register. The data will be shifted up in the following fashion S8→S7→S6→S5→S4→S3→S2→S1→S→T and data in S1 register is copied to S8 register as shown in FIG. 6b. Because the bottom eight registers are in a circular buffer, the hardware wraps rather than underflows and one can keep taking more copies of the last eight items taken from the bottom of the stack forever. It is the fastest way to duplicate a pattern of eight words or four or two or one because the bottom eight will be read over and over if a program keeps taking values from the stack.

FIG. 7a illustrates one embodiment of a method of shifting data to avoid overflow when decode logic section 150 detects a push instruction to be performed on the return stack. The decode logic section 150 provides an active push signal to the multiplexers 305a through 305h. A ten cell deep push down stack is formed by the registers R 125A, and R1 through R8 and on receiving an active control input push signal, the new data will be written to the top register, in this case 18-bit R register 125A and the data stored in 18-bit return stack registers R1 through R8 will be shifted down to the 18-bit return stack registers R2 through R8. The data that was previously present in the stack registers will be shifted down in the following fashion R→R1→R2→R3→R4→R5→R6→R7→R8 and the data in the R8 register is lost as shown in FIG. 7a. There is no stack overflow and if more than ten items are written, only the last ten will remain; each store after the first ten will overwrite one of the R1 through R8 registers.

FIG. 7b illustrates one embodiment of a method of shifting data to avoid underflow when decode logic section 150 detects a pop instruction to be performed on the return stack 120. The decode logic section 150 provides an active pop control signal 410 to the multiplexers 305a through 305h. A ten cell deep pop up stack is formed by the registers R, and R1 through R8 and on receiving an active pop signal 410 then the data from the registers will be shifted up and the data from R1 register 210₉ will be copied to the R8 register 210₁₆. The data will be shifted up in the following fashion R8→R7→R6→R5→R4→R3→R2→R1→R and data in R1 is copied to R8 stack register as shown in FIG. 7b. Because the bottom eight registers are in a circular buffer, the hardware wraps rather than underflows and one can keep taking more copies of the last eight items taken from the bottom of the stack forever. It is the fastest way to duplicate a pattern of eight words or four or two or one because the bottom eight will be read over and over if a program keeps taking values from the stack.

It will be apparent to those familiar with the art that in yet an alternate embodiment, the hardware portion that is the smallest repeated element of array 16 on chip 14 may have a form that is different from a dual-stack computer with RAM and ROM memory, without departing from the spirit and scope of the invention. This invention is described with reference to the Figures, in which like numbers represent the same or similar elements. While this invention is described in terms of modes for achieving this invention's objectives, it will be appreciated by those skilled in the art that variations may be accomplished in view of these teachings without deviating from the spirit or scope of the presently claimed invention.

The embodiments and variations of the invention described herein, and/or shown in the drawings, are presented by way of example only and are not limiting as to the scope of the invention. Unless otherwise specifically stated, individual aspects and components of the invention may be omitted or modified for a variety of applications while remaining within the spirit and scope of the claimed invention, since it is intended that the present invention is adaptable to many variations.

### INDUSTRIAL APPLICABILITY

The inventive computers 100, stacks 120, 130, and 145A-C and method of FIG. 5 are intended to be widely used in a great variety of computer applications. It is expected that they will be particularly useful in applications where significant computing power is required, and yet power consumption and heat production are important considerations.

As discussed previously herein, the applicability of the present invention is such that the sharing of information and resources between the computers in an array is greatly enhanced, both in speed a versatility. Also, communications between a computer array and other devices is enhanced according to the described method and means.

Since computers 100, stacks 120, 130, and 145A-C and method of FIG. 5 of the present invention may be readily produced and integrated with existing tasks, input/output devices, and the like, and since the advantages as described herein are provided, it is expected that they will be readily accepted in the industry. For these and other reasons, it is expected that the utility and industrial applicability of the invention will be both significant in scope and long lasting in duration.

1. A stack computer processor, comprising:
a first stack, comprising of plurality of data registers wherein each of said data stack can accommodate an 18-bit instruction word; and,
a plurality of multiplexers capable of receiving push and pop control signals which are coupled to the data registers of said first stack; and,
a decode logic section that provides the push and pop control signals to the plurality of multiplexers.

2. A stack computer processor as in claim 1, wherein first stack is a data stack.

3. A stack computer processor as in claim 2, wherein said multiplexers use one-hot logic such that the multiplexer shifts the data up or down when only one of the push and pop control signals is active.

4. A stack computer processor as in claim 1, wherein the first stack is a return stack.

5. Apparatus of claim 4 wherein the multiplexers use one-hot logic such that the multiplexer shifts the data up or down when only one of the push and pop control signals is active.

6. A method for operating a stack computer having a data stack with a plurality of registers comprising the steps of receiving data that needs to the written to the data stack, and, shifting data down the data registers on receiving an active push signal wherein the data received is written to the top data register of the data stack and the data from the top data register of said stack register is shifted to the successive data register wherein the process of shifting the data is carried out until the last data register is written with the data from the preceding data register of the data stack.

7. A method for operating a stack computer having a data stack with a plurality of registers as in claim 6, wherein the computer further comprises a multiplexer wherein the shifting data down step is carried out by the multiplexer, and wherein the multiplexer provides the data of the preceding register as the input to the succeeding data register.

8. A method for operating a stack computer as in claim 6, wherein the computer further comprises a return stack with a plurality of registers, comprising the steps of receiving data that needs to the written to the return stack, and, shifting data down the return registers on receiving an active push signal wherein the data received is written to the top return register of the return stack, and, wherein the data from the top return register of the stack register is shifted to the successive return register; and, shifting data until the last return register is written with the data from the preceding return register of the return stack.

9. A method for operating a stack computer further comprising a multiplexer as in claim 8, wherein the shifting data down step is carried out by the multiplexer, and wherein the multiplexer provides the data of the preceding register as the input to the succeeding data register.

10. A method for operating a stack computer as in claim 8, further comprising the steps of,
providing data from the data stack; shifting data up the data registers on receiving an active pop signal wherein data in the top data register of the return stack is provided as the data, and, further shifting data from the successive register to the top data register wherein the process of shifting the data is carried until the data from the last data register is written to the preceding data register of the data stack and data from the top data register is copied to the last data register.

11. A method for operating a stack computer further comprising a multiplexer as in claim 10, wherein the shifting data up step is carried out by said multiplexer, wherein the multiplexer provides the data of the succeeding register as the input to the preceding data register.

12. A method for operating a stack computer which includes a return stack with a plurality of registers comprising the steps of providing data from the return stack, and, shifting data up the return registers upon the receipt of an active pop signal wherein data in the top return register of the return stack is provided to the processor and wherein data from the successive return register is shifted to the top return register; and wherein the process of shifting the data is carried out until the data from the last return register is written to the preceding return register of the return stack and data from the top return register is copied to the last return register.

13. A method for operating a stack computer further comprising a multiplexer as in claim 12, wherein the shifting data step up is carried out by the multiplexer, and wherein the multiplexer provides the data of the succeeding register as the input to the preceding data register.

14. A method for operating a stack computer further comprising a multiplexer as in claim 13, wherein the multiplexers use one-hot logic such that the multiplexer shifts the data up or down when only one of the push and pop control signals is active.
